(19) United States
(12) Patent Application Publication
(10) Pub. No.: US 2022/0307687 A1
(43) Pub. Date: Sep. 29, 2022

(54) REACTOR CAPABLE OF CARBONIZED DRYING AND BURNING VOLATILE GASES TOGETHER WITH TOXIC GASES

(71) Applicants: Senol Faik OZYAMAN, Canakkale (TR); Zeynep DURDU, Canakkale (TR)

(72) Inventor: Senol Faik OZYAMAN, Canakkale (TR)

(21) Appl. No.: 17/258,654

(22) PCT Filed: Oct. 3, 2019
(86) PCT No.: PCT/TR2019/050822

§ 371 Date: Jan. 7, 2021

(51) Int. Cl. F23G 5/05; F23G 5/44

(52) U.S. Cl. CPC F23G 5/05; F23G 5/444; F23G 2201/10; F23G 2206/10

(57) ABSTRACT

A solid-fuel burning and drying unit capable of carbonized drying and burning of toxic gases, having a main body with a fuel cell configured in the main body, a barrier surface which closes the fuel cell from the upper region and enables combustion of toxic and volatile gases in the combustion zone without mixing with the atmosphere, fuel supply elements and fuel discharge elements that deliver fuels to be burned into the fuel cell, wherein the said main body contains a drying unit in which the damp fuel is dried by heat from the combustion zone by generating frictional energy by rotating through the configured drive element and coils on the axis of rotation (z).

### TECHNICAL FIELD

The invention relates to a reactor that is capable of drying and burning coal, forest waste, bituminous shale, dung, chicken manure, sewage sludge, hazardous or non-hazardous industrial wastes, hazardous hospital wastes and domestic wastes and that of burning the solid fuel which is carbonized dried in the oxygen-free environment on the reactor at 97% efficiency with toxic gases, flue gas emitted from the chimney to the atmosphere with an emission rate of 80% lower than the natural gas emission values known as clean energy and and the chimney gas output emission values well below the emission limit values of the Ministry of Environment.

### PRIOR ART

Bituminous schist, which constitutes one third of the world, is rock gas, in other words. This reserve is an endless one. However, the burning of the world's largest energy source is prohibited because other technologies in the world give too high emissions. The part that is produced as rock gas with high cost is relatively used but is not in demand today due to the fact that rock gas extraction costs 7 times more than natural gas production. However, our invention, which will be presented in detail below, performs the process of converting bituminous schist into energy by starting from the top of the ground in the form of rocks in our technology by breaking it in the size of flints in the stone crushing plant without any other contribution or process. Our invention emits from the flue gas to the atmosphere with an emission value close to zero and far below the limit value of the Ministry of Environment with 97% combustion efficiency in the combustion zone. It is the only technology that can burn directly with the cost of raw materials like $1 and reduces energy production costs by 80%. Although this situation decreases the production cost of the world's biggest energy problem, the bituminous schist reserve is the largest known energy source that will produce energy for our country and our world for thousands of years.

Today, fuel, recycling and energy production are of high importance and have a high impact on the development of countries. In particular, the efficient use and combustion of the already used solid fuels, and even the generation of energy through them, provide high advantages to the national economy.

Today, the units and systems that burn solid fuels in the most efficient way and convert them into energy are almost nonexistent. Currently used solid fuels (high-quality coal) are imported solid fuels of foreign origin, aiming for more efficiency and lower emission ratios. However, in our country and other countries, the combustion efficiency of solid fuel-burning boilers for heating purposes is between 40% and 60% depending on the quality of the fuel and the efficiency of fluidized bed boilers used in power plants is between 70% and 80% and the combustion efficiency is low, thus it gives high emissions to the atmosphere. All the environmental organizations in the world and the Kyoto Protocol oppose the production of energy from solid fuels, and the power plants are shut down. Therefore, energy costs increase dramatically because of their transition to other energy systems with high energy costs.

Coal is in the range of 1000 Kcal to 2,500 Kcal, having 25% humidity to 55% humidity and constitutes 80% of our coal reserve. Having high humidity and low kcal reduces its combustion efficiency as well as it pollutes the environment by throwing very high emission flue gas into the atmosphere from the chimney. More important is that it affects human health badly and the earth becomes uninhabitable.

The patent application of our numbered TR 2010/05272 works industrially, when the emission measurement values in the emission report we have commissioned to accredited laboratories, and the pages 30-31-32/34 of the emission report in Annex (1) are examined, it will be seen that the emission values are below the natural gas, known as a clean energy source, and far below the limit values of the Ministry of Environment. The reason is that in both inventions the combustion efficiency is 97% and the combustion cell reaches a temperature of 1800 C.° within the flame circle and the combustion of all of the toxic and third gases rises from the chimney to the atmosphere with an emission close to zero. 509/5000 In other existing technologies, the combustion chamber (furnace) can reach up to 800° C. to 850° C. The volatile gases start to burn at 900° C., so as the 17% of the volatile and toxic gases can be burned, the remaining 83% exits the chimney before burning and gives very high emissions to the atmosphere. Since our invention reaches a high temperature of 1800° C., the energy transfer is very high since the radiation efficiency is very high and the radiation emission is much higher than other technologies. In addition to providing 80% energy savings, our invention throws flue gas into the atmosphere with nearly zero emissions. Thus, it is much cleaner energy and environmentally friendly than natural gas.

The invention by S̨enol Faik ÖZYAMAN, with application no TR2010/05272 is a solid fuel-burning unit comprising a fuel supply chamber wherein the fuel to be sent for combustion to the combustion region found in the body is placed and the feed mechanism carrying the solid fuel found in the said chamber forward. This unit comprises a main burning block having an air and fuel cell connected to said solid fuel supply chamber, said main burning block having a plurality of air outlet vents formed on an external wall surface thereof; and a preventive surface positioned at a distance over said external wall surface of said main burning block so as to form a closed volume.

The unit described in document TR2010/05272 has the ability to burn solid fuels efficiently. However, it has the ability to burn only solid fuels. Drying process cannot be done with this unit. Solid fuels are delivered to the fuel cell by means of helices and the slag and residues of the burned fuels are automatically discharged out of the system. Especially in the case of burning coal, the volatile and toxic gases in the coal structure prevented from mixing into the atmosphere due to the structure of the fuel cell. This invention of S̨enol Faik Özyaman has been patented in America, Russia, Australia, and some European countries. The new patent study, which will be described below, includes new and superior features developed by S̨enol Faik Özyaman on the unit number TR2010/05272.

### DESCRIPTION OF THE INVENTION

The invention is intended to produce a system which, unlike the systems used in the current technique, that brings a new development to this area.

One purpose of the invention to provide the organic solid fuels to be burned at the same time as the drying unit integrated in the unit referred to in the patent application TR2010/05272, to the amount of moisture by being exposed to high temperature in the organic solid fuel-formed drying section containing 900 C ° flue gas in an oxygen-free environment formed on the one hand, and accordingly the carbonization occurs while the fuel is below the moisture content of the fuel during the time it will remain in an oxygen-free environment. Solid fuel does not absorb moisture from the outside moisture again, which gives it a very important feature. As solid fuel turns into a quality fuel, it also becomes storable in the open area as it will not absorb any more moisture. Thus, a system in which both burning and drying are combined is provided.

As a new expansion, the barrier surface and the burning block in our patent application TR2010/05272. As a result of the structural change we made as a result of our r&d work, the barrier surface consisting of two parts and the burning block are specified in the description and figures, and are made dome-like to withstand high temperatures. The working life of the specially designed reflector material is 10 times longer than that of the structure in the patent application no. TR2010/05272 and it is documented in our r&d studies and industrially speaking, the reactor works smoothly.

Before the structural change was made, while the CO (carbon monoxide) in the flue gas emission measurements in the TR 2010/05272 patent application was between 12 pm and 30 ppm in the flue gas, the structural design revision we made as a result of the r&d, the structural change we made by combining the barrier surface and the burning block structure, the barrier surface is prepared with special additives at an operating temperature of 2000° C.

The result of the structural changes we have made in fire concrete refractory concrete and the combustion cell in the burning chamber reaches 1800° C., the result of the flue gas emission values of CO (carbon monoxide), as one of the accredited laboratory's measurements, is much lower than the other technology mentioned above. It is understood from the measurements of the flue gas emission report of the accredited laboratory.

CO (carbon monoxide) has been shown to be in the range of 0.015 ppm to 1 ppm, and the limit value of the Ministry of Environment is two over 375 ppm. In other words, the Ministry of Environment has proven with the flue gas emission report of the Accredited Laboratory that the flue gas limit value has been released to the atmosphere at 1 ppm at 375 ppm, and the organic clean energy in the world is below the emission values, even close to zero. The Emission Report will show that all other emission parameters are similarly very low.

Another purpose of the invention is that it has the ability to burn fuel with 80% efficiency using organic fuels dried by carbonization. For example, instead of the other boilers that burn 100 kg/hour of organic solid fuel, our reactor burns 20 kg/hour of organic solid fuel, producing the same energy with a near zero-emission.

Today, it is known that the most important problem in the world is energy costs. Our invention is very important from this point of view, and saving 80% would increase the reserve of organic fuels by twice as much. As an example, the life of low-calorie high humidity coals in our country has been calculated as 220 years. When our invention, the reactor (boiler) and the carbonization drying technology we designed on the reactor are used, it is anticipated that the life of our high-humidity low-calorie coal reserve will increase to 600 years.

In addition, in comparison to old boiler technologies, our invention can produce cleaner energy than natural gas, which is known as clean energy with saving 80% fuel (energy), and also our invention produces the same energy as the old technology produces with using 80% less solid fuel.

Another purpose of the invention is to contact the humid solid fuel with the flue gas by entering the flue gas into the atmosphere at 74° C. with the flue gas vapor during the passage of the flue gas from the drying unit to 900° C. formed in the combustion chamber of the deoxygenated medium in the solid fuel drying unit to dry solid fuel with maximum % 80 humidity by carbonizing.

By reducing the solid fuel below the moisture content of the young coal, (Elbistan coal 1070 kg/Kcal with 55% moisture) Elbistan coal having 55% moisture is dried with the carbonization technology of our invention is reduced to 5% moisture, and in the process every 1% humidity per calorie increases 50 Kg/Kcal. Thus, by increasing the moisture content of 50×50 kg/Kcal=2500 kg/Kcal, Elbistan coal reaches 3570 kg/Kcal when new 2500 kg/Kcal is added to its original calorie of 1070 Kg/Kcal and reaches to old and high-quality coal category.

As an example: the maximum amount of moisture in coal is 55% and the internal moisture of the coal as we mentioned is in the range of 6% to 8% in general. So, in our invention, we need to reduce the moisture of such coal to one point below the internal moisture percent. The coal dried by carbonization does not moisturize again and even if it is wet exposing to rain in an open area, the coal does not moisturize again, and even if high stocks are made, the coal does not ignite in stock.

Our invention is able to burn solid fuel with very low, even near-zero-emissions. It also introduces an environmentally friendly system.

Another purpose of the invention is to reduce the energy costs of drying by 90% compared to existing technologies, as it does the drying process within itself. It is the introduction of an economic product where costs are reduced without the need for businesses to budget separately to dry solid fuel.

The invention removes 100% of the sewage sludge, bovine manure, domestic waste, hazardous hospital and industrial wastes, industrial treatment sludge. In addition, the present invention is industrially operable, which can burn with near-zero emissions.

Another purpose of the invention is to preserve the solid fuel ashes obtained from incineration and to use them as a waste of ash in cement, organic fertilizer and different industries.

Another purpose of the invention is that the current technology requires the removal of ashes every day. However, with this system, it is possible to automatically retrieve and store the ashes.

Another purpose of the invention was to obtain steam and generate electricity by installing a coil on the system. Hot water can be obtained. Also, it is possible to obtain hot water and hot air for heating the spaces.

In order to fulfill the above-described purposes, the present invention is a solid-fuel burning and drying unit capable of carbonized drying and burning of toxic gases, having a main body, comprising a fuel cell configured in the said main body, a barrier surface which closes said fuel cell from the upper region and enables combustion of toxic and volatile gases in the combustion zone without mixing with the atmosphere, fuel supply elements and fuel discharge elements that deliver fuels to be burned into the fuel cell, wherein; comprising,
that the said main body contains a drying unit in which the damp fuel is dried by heat from the hot zone by generating frictional energy by rotating through the configured drive element and (z) helices on the axis of rotation.

### BRIEF DESCRIPTION OF THE FIGURES

FIG. 1 is the general perspective view of the reactor of the invention.

FIG. 2 is the section perspective view of the reactor of the invention.

FIG. 3 is the section perspective view of the reactor of the invention from a different angle.

FIG. 4 is the top view of the blocking surface of the burning zone in the reactor of the invention.

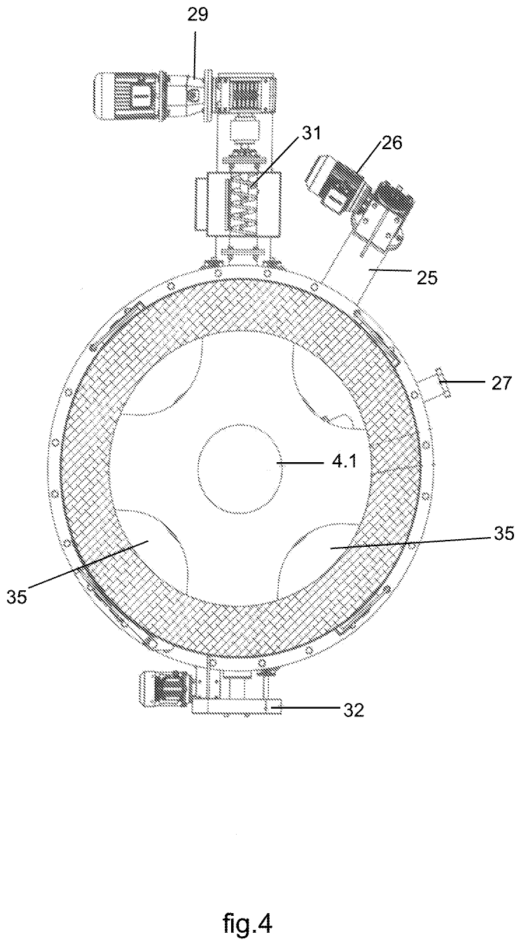

FIG. 5 is the cross-sectional perspective view of the ash-collecting zone of the reactor of the invention from the top.

FIG. 6: Close-up exterior elevation perspective view of the drying unit of the invention.

### REFERENCE NUMBERS

```
  1. Burning and drying unit
  2. Fuel cell
  2.1-Combustion air feeding tube
  2.2-Combustion air vent holes
  3. Ash discharge cone
  4. Blocking surface
  4.1 Bedding zone
  5. Reflector material (fired brick)
  6-Hot Zone
  7-Combustion zone
  8-Particle collection zone
  8.1 Particle discharge pipe
  8.2 Particle discharge outlet
  8.3-Open area with particle impact
screen
  8.4-Particle side wall
  9-Bearing feet
10-Drying unit
11 -Coil
11.1-Drying unit inlet
12-Main shaft of solid fuel mixer
13-Engine reducer
14-Flue gas pipe
15-Access channel to drying unit
15.1-Discharge fan to the drying
unit
15.2-Flue gas fan engine
15.3.-Transport pipe
16-Friction surface
16.1 Side walls
16.2. Bottom plate
17-Temperature sensor
18-Bunker
19-Fuel transport pipe
19.1-Coil
19.2-Discharge pipe.
20-Fuel discharge outlet
20.1-Discharge pipe.
21-Propulsion element
22-Steam collection and
discharge pipe
23-Steam outlet
24-Steam suction line
25-Ash discharge line
25.1-Ash discharge pipe
and apparatus
26-Ash discharge engine
group
27-Incineration air provider
28-Fuel dispatch main
engine
29-Fuel supply drive unit
30-Main Body
31-Fuel supply transport
line
31.1-Conical coil line
32-Slag crusher unit
33-Conical coil
34-Fuel transport shaft
35-Flue gas cavities
36-Combustion cell
peepholes
36.1 Combustion cell cover
37-Flue gas transition gap
Z-Axis of rotation
```

### DETAILED DESCRIPTION OF THE INVENTION

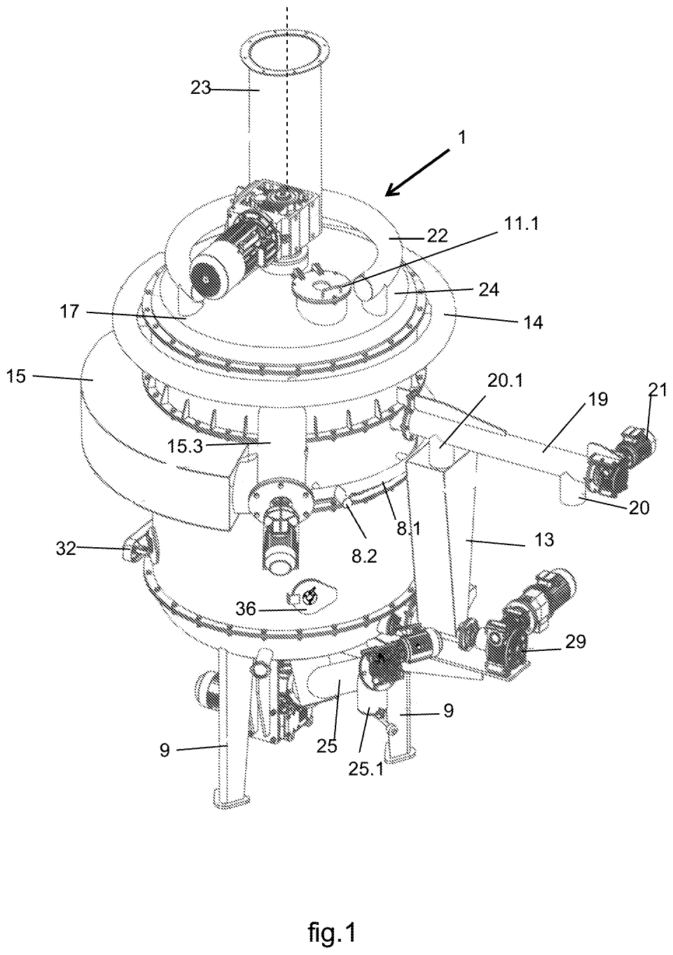

The solid fuel burning and drying unit (1), shown in FIG. 1, is capable of drying by carbonizing and burning the third gas together with the toxic gases. In general, it has a main body (30), comprising a fuel cell (2) configured in the said main body (30), flue gas cavities (35) providing flue gas outlet towards the outer wall of the upper zone dome structure, a barrier surface (4) which closes said fuel cell from the upper region and enables combustion of toxic and volatile gases in the combustion zone (7) without mixing with the atmosphere, fuel supply elements and fuel discharge elements that deliver fuels to be burned into the fuel cell. The said fuel cell (2) also contains the combustion air supply tube (2.1) and the combustion air vent holes (2.2). The system also includes an ash discharge cone (3), ash discharge line (25), ash discharge pipe and apparatus (25.1), ash discharge engine group (26), incineration air provider (27), fuel dispatch main engine (28) and fuel supply drive unit (29).

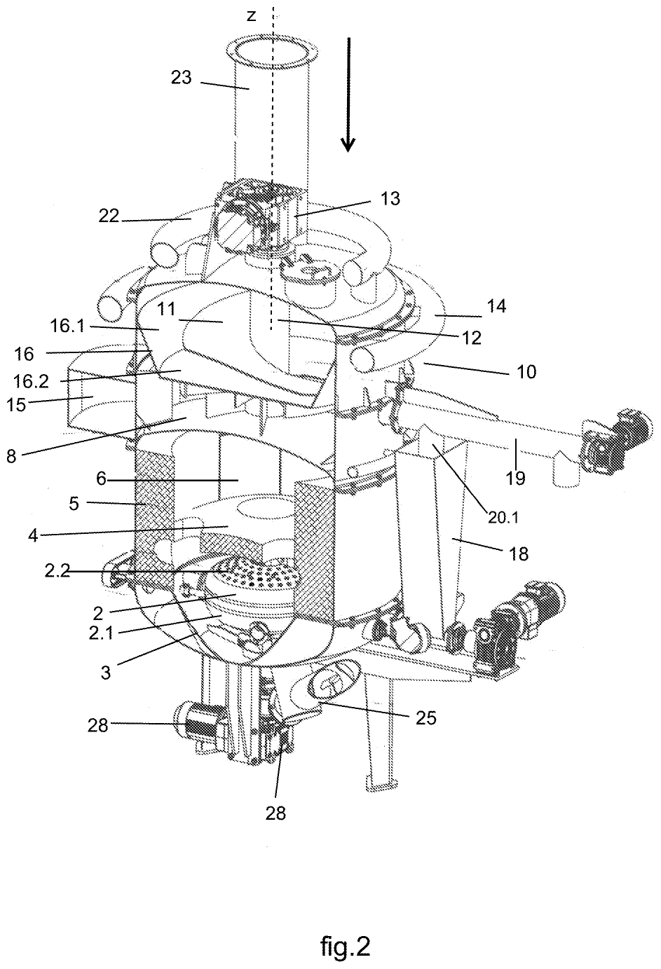

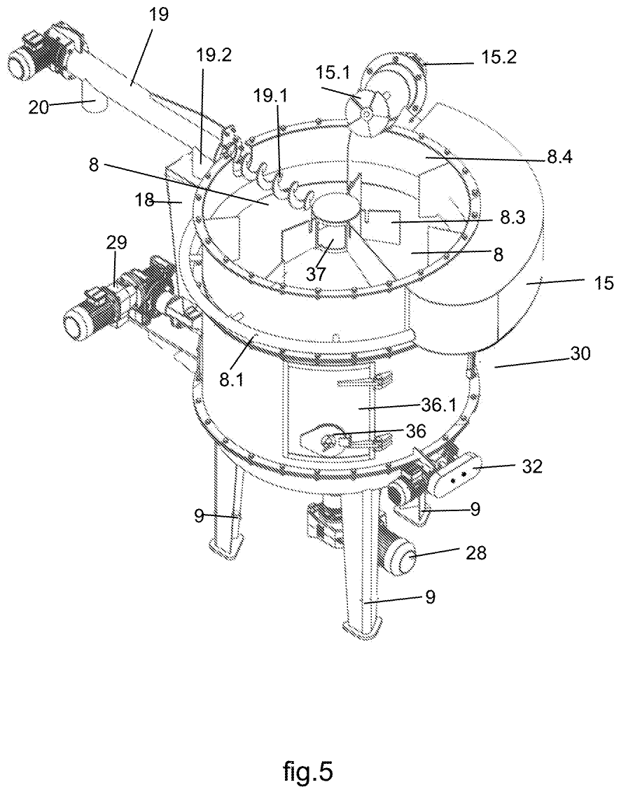

The combustion and drying unit (1), shown in FIG. 2, as its inventive feature comprises a drive element configured on the main body (30) and a drying unit (10) which rotates by means of augers (11) in the rotation axis (z) and generates frictional energy and dried the heat and moist fuel coming from the hot zone. The drying unit (10) has a solid fuel mixer main shaft (12), where rotational motion is generated by at least one motor reducer (13), and a friction surface (16) that turns damp fuel by means of coils (11) configured on this solid fuel mixer main shaft (12). The said drying unit (10) includes sidewalls with conical surfaces (16.1) and a particle collection zone (8) with particle impact screen (8.3) that allows the passage of particles to the particle collection zone (8) seen in FIG. 5 and a particle collection zone (8) where the right amount of suction is done to the particle evacuation outlet (8.2) and the particles in the drying unit (10) are discharged by means of the discharge tube (8.1) shown in FIG. 1. In the reactor combustion zone (7) flue gas fan suction pipe (FIG. 1) also has a flue gas pipe (14) where hot air is connected by a T connection and allows hot air to circulate. The combustion and drying unit (1) has bearing feet (9).

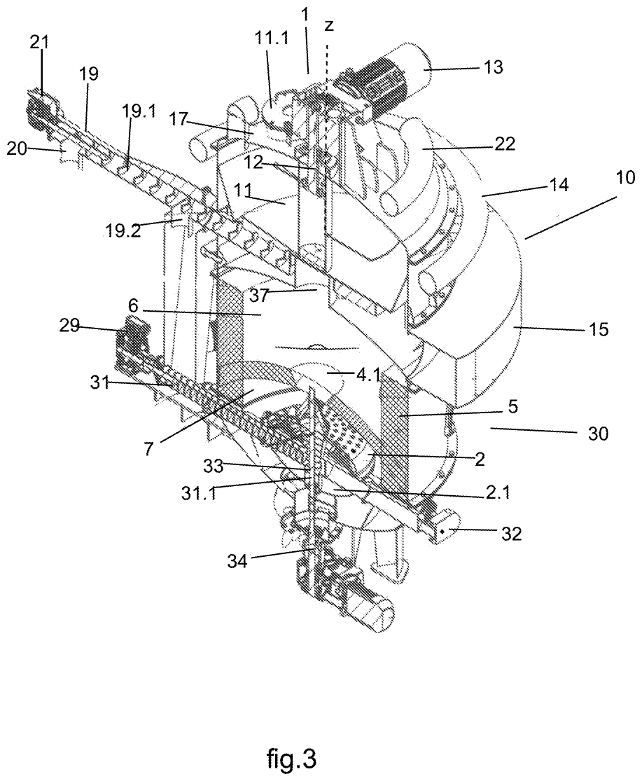

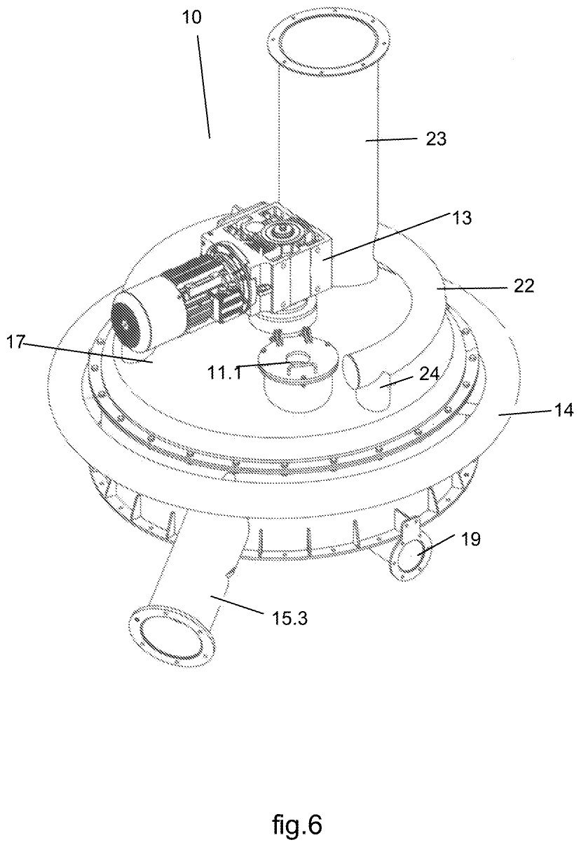

On the other hand, for the fuel to be dried, the bunker (18) in FIG. 1, the fuel cell (2) in the bunker (18) in FIG. 3 that show the solid fuel that comes with the fuel supply transport line, as well as the fuel cell (2) fed through a conical coil line, the heat energy obtained by the fuel is available. The central shaft of the reactor from the combustion chamber in 900° C. flue-gas drying unit (10) to the drying unit transition line (15) provides the transportation of the flue gas to the drying unit, under 900° C. from the combustion chamber to the drying unit by absorbing the flue gas discharge fan (15.1) and flue gas fan motor (15.2) provides. This structure also contains a transport pipe (15.3) (see FIG. 6). It contains the coil (19.1) which allows transport to the drying unit (10), and the fuel transport pipe (19), the propulsion element (21) and the discharge pipe (19.2) which provide rotational movement to the said coil. In addition, the said drying unit (10) contains at least one steam suction line (24), a steam collection and discharge pipe (22), and at least one steam outlet (23), which allows the said steam to be delivered to the outside environment and/or to the line where the steam will be used.

The operation of the combustion and drying unit (1) in FIG. 3 is as follows; the fuels transferred to the fuel cell (2) by means of the fuel supply transport line (31) are subject to combustion from this region. By means of the barrier surface (4) having the bearing region (4.1) in the fuel cell (2), the fuels are burned together with the volatile and toxic gases with an emission close to zero. The blocking surface (4) and fuel cell (2) are surrounded by the reflector material (5). Just above the hot zone (6), there is the particle collection zone (8) and above it, there is the drying unit (10). The fuel supply transport line (31) also has a conical coil line (31.1). On the other hand, the conical coil (33), the fuel transport shaft (34), the flue gas cavities (35), the combustion chamber peepholes (36), the combustion chamber cover (36.1) and the flue gas transition cavity (37) is integrated into the system.

The mode of operation of the drying unit (10) is as follows; the fuels to be dried into the drying unit (10) are supplied from any outside supply bunker to the moist solid fuel drying unit (11.1). The fuel to be dried in the drying unit (10) is subjected to rotational effect in this area. The moist fuel to be dried by transferring the blades of the solid fuel mixer main shaft (12) in the rotation axis of the coil (11) during rotation will be continuously rotated in this area. The material (moist fuel) is taken from the bottom to the top and the fuel to be dried is constantly mixed. Furthermore, the high temperature from the lower hot zone (6) to the environment is provided by the bottom plate (16.2). This environment is oxygen-free environment. Its transfer by means of the coil (11) also creates a frictional effect. Accordingly, a temperature is formed by friction in the oxygen-free environment. Also, 900° C. provides drying as the flue gas passes through the drying unit. When the moist solid-fuel internal temperature of the product to be dried reaches 105° C., the temperature sensor (17) is activated and the dry solid fuel is discharged to the outside via the fuel discharge outlet (20). The benefits of the fuel discharge output (20) are clearly evident when delivering high-calorie high-quality, dehumidified solid fuel to a sack or a tractor or trailer and obtaining energy, as well as recycling and disposing of 100%. During the discharge of the dried solid fuel to the drying unit by the propulsion of the propulsion element (21), the dried fuel is discharged by the discharge pipe (20.1) to the fuel supply body and the dried fuel is discharged by the discharge outlet (20).

At the same time, the transition channel from the flue gas outlet to the drying unit (15) via the flue gas pipe (14) is given into the hot air drying unit (10), which is received through a T pipe. The steam generated here is given out by means of the steam suction line (24) and steam outlet (23). Or it is possible to transport steam through pipes to a region where steam is needed.

During the passage of flue gas in the drying unit (10), the particles are oriented towards the corner of the side walls (8.4) with the force of the center by the rotational effect, and through the open field with the particle impact screen (8.3) and the material weight, the particles fall from this screen opening area to the particle collection zone (8). Particles falling in this zone are evacuated to the exterior zone via the discharge pipe (8.1) and a suction line and the particle discharge outlet (8.2).

The drying unit (10) has a structure bearing the same rotation axis (z) and the same main body (30) center and moving from the single drive center. At the same time, together with the heat from the hot zone (6), the rotational and frictional effect created by the coils (11), and the effect of the hot air from the transition line (15) to the drying unit, it has a superior drying feature where a three-times effective drying is performed.

The drying unit (10) of FIG. 2 rotates the drying motor reducer (13) and the first factor, which consists of the mixing of the moisturized solid fuel mixer of the transfer coil (11), causes the solid fuel's core temperature to reach 50° C. The second factor is the heat transfer of the heat generated by burning solid fuel through the heating bottom plate (16.2) of the fuel cell (2) under the heat generated by the fuel cell (6) at the top of the fuel cell is 1800° C. and in the chimney gas hot zone at the bottom of the drying unit at 900° C. The third factor is that the solid fuel which is being installed due to the high temperature flue gas oxygen-free environment during mixing of solid fuel in an oxygen-free environment, which passes through the access channel (15) of the flue gas from the central cavity of the reactor combustion cell, does not burn and does not fire and does not present danger. 900° C. flue-gas of solid fuel in the drying unit during the drying, the heat energy 90% of solid fuel drying with flue gas in spent steam outlet pipe (chimney) 74° C. water to steam and exits as converted into automation control of agricultural land is to be used as irrigation water. By combining the three factors mentioned above, the drying process is provided with 90% lower cost than existing technologies. In addition, while the amount of dehumidification in solid fuels cannot exceed the maximum 15% in other current technologies, drying cost of the technology in our invention, which delivers 80% moisture reaching up to 7 times of the humidity of the current technology, it also lowers the max 15% dehumidification cost of the current technology by 80% via the carbonized drying process.

Thus, the heat energy obtained from the heat center sends the flue gas drying unit (10) to the drying unit transition channel (15) of the flue gas shown in an oxygen-free environment and the drying capacity is 750 kg/hour. In the test performed by the accredited laboratory, 750 kg/h drying the fuel in 1 hour and reducing it from 80% moisture to 2% moisture, dried solid fuel (Egg hatching manure) is 80% moist calorific value is 150 kg/Kcal is reduced to 2 humidity and increased to 3570 kg/Kcal, 1800 c ° combustion zone (7) by descending from 750 kg laying manure to 2% moisture, dry carbonized 3570 kg/kcal solid fuel is obtained at 165 kg/hour. 15% of the solid fuel dried by carbonization is used to obtain heat energy by burning in the reactor combustion zone (egg chicken manure), approximately 24.5 kg/hour solid fuel is burned to the fuel cell by obtaining heat energy by carbonizing the drying is carried out. The excess fuel obtained by 24.5 kg/hour solid fuel used by carbonized dried solid fuel (egg chicken manure) to obtain heat energy is 140.5 kg/hour. While the solid fuel with an economical value of 3750 kcal/kg is obtained, organic fertilizer which is an environmental disaster is 100% disposed of and converted to energy.

1. A solid-fuel burning and drying unit capable of carbonized drying and burning of toxic gases, having a main body comprising a fuel cell configured in the said main body, flue gas cavities providing flue gas outlet towards an outer wall of an upper zone dome structure, a barrier surface which closes said fuel cell from the upper region and enables combustion of toxic and volatile gases in a combustion zone without mixing with the atmosphere, fuel supply elements and fuel discharge elements that deliver fuels to be burned into the fuel cell, wherein the said main body contains a drying unit in which the damp fuel is dried by heat from the combustion zone by generating frictional energy by rotating through the configured drive element and coils on the axis of rotation (z).

2. A solid fuel burning and drying unit according to claim 1, comprising a drying unit having a solid fuel mixer main shaft, where rotational motion is generated by at least one motor reducer, and a friction surface that turns damp fuel by means of coils configured on this solid fuel mixer main shaft.

3. A solid fuel burning and drying unit according to claim 1, comprising a particle collection zone where the right amount of suction is done to a particle evacuation outlet and the particles in the drying unit are discharged by means of a discharge tube.

4. A solid fuel burning and drying unit according to claim 1, wherein, the said drying unit comprises sidewalls with conical surfaces and a particle impact screen that allows the passage of particles to the particle collection zone.

5. A solid fuel burning and drying unit according to claim 1, comprising the hot air in the access channel to the drying unit is connected with a T connection and contains the flue gas pipe which allows the hot air to be circulated.

6. A solid fuel burning and drying unit according to claim 1, comprising a drying unit Inlet which allows the transfer of moist solid fuel from any bunker other than the fuel to be dried to the drying unit.

7. A solid fuel burning and drying unit according to claim 1, wherein, the said drying unit comprises at least one steam suction line, a steam collection and discharge pipe, and at least one steam outlet, which allows the said steam to be delivered to the outside environment and/or to the line where the steam will be used.

8. A solid fuel burning and drying unit according to claim 1, comprising a drying unit bearing at the same rotation axis (z) and at the same center of the main body and moving from the same drive element.

9. A solid fuel burning and drying unit according to claim 1, comprising a drying unit in which three effective drying is done with the effect of heat from a Hot Zone and hot air from the flue gas outlet and the rotational and frictional effect created by means of coils.

10. A solid fuel burning and drying unit according to claim 3, comprising particle side walls in which the particles are oriented with the force of the center with the rotational effect during the flue gas passage in the said drying unit.

11. A solid fuel burning and drying unit according to claim 1, comprising at least one access channel to the drying unit, and this access channel, a discharge fan, a flue gas fan motor and a transfer pipe which absorb 900° C. flue gas from the combustion chamber, and transport the flue gas to the drying unit.

12. A solid fuel burning and drying unit according to claim 2, comprising a fuel cell in the upper part of the temperature formed in the combustion zone at 1800° C., and the base sheet from which the heat generated in the flue gas hot zone of 900° C. is transferred.

13. A solid fuel burning and drying unit according to claim 1, comprising a temperature sensor which is activated and the dry solid fuel is discharged to the outside via the fuel discharge outlet, when the moist solid-fuel internal temperature of the product to be dried reaches 105° C.

14. A solid fuel burning and drying unit according to claim 1, comprising a coil which allows transport to the drying unit, and the fuel transport pipe, the propulsion element and the discharge pipe which provide rotational movement to the said coil.
